(19) United States
(12) Patent Application Publication
(10) Pub. No.: US 2020/0167542 A1
(43) Pub. Date: May 28, 2020

(54) Electronic Device, Method For Controlling The Same, And Computer Readable Storage Medium

(71) Applicant: Shanghai Harvest Intelligence Technology Co., Ltd., Shanghai (CN)

(72) Inventors: Xueke HU, Shanghai (CN); Tianyang WANG, Shanghai (CN); Fei WANG, Shanghai (CN); Sheng FENG, Shanghai (CN); Fengjun GU, Shanghai (CN); Jiandong HUANG, Shanghai (CN)

(73) Assignee: Shanghai Harvest Intelligence Technology Co., Ltd., Shanghai (CN)

(21) Appl. No.: 16/693,024

(22) Filed: Nov. 22, 2019

(30) Foreign Application Priority Data
Nov. 22, 2018 (CN) 201811398792.7

(51) Int. Cl. G06K 9/00; G07C 9/00

(52) U.S. Cl. CPC G06K 9/0004; G07C 9/00158; G06K 9/00087

(57) ABSTRACT

An electronic device, a method for controlling the same and computer readable storage medium is provided. The method includes when an electronic device is in a locked state and receives at least two position information of fingerprints, lighting pixels in a light source area corresponding to the position information of fingerprints, wherein a screen of the electronic device corresponds to at least two light source areas arranged in topology, each of the at least two light source areas includes at least one pixel, and there are unlit pixels configured in an interval between adjacent light source areas, sampling fingerprint data on positions of the screen corresponding to the position information of fingerprints; identifying the sampled fingerprint data; and controlling the electronic device to unlock or to remain in a locked state based on the identification result.

### CROSS-REFERENCE TO RELATED APPLICATIONS

This application claims the benefit of priority to Chinese patent application No. 201811398792.7, filed on Nov. 22, 2018. The entire contents of this application are hereby incorporated herein by reference.

### TECHNICAL FIELD

The present disclosure relates to the field of electronic devices, and more particularly, to an electronic device, a method for controlling the electronic device and a computer readable storage medium.

### BACKGROUND

With the development of information technology, biometrics identification method plays a more and more important role in protecting information security. Among them, fingerprint identification has become one of critical unlock technologies for widely used devices in mobile internet fields.

Nowadays, under the trend that the screen occupation ratio becomes larger and larger in electronic devices, electronic devices with full screen, such as full screen mobile phones, gradually come forth in the market. There is no fingerprint identification buttons configured on the full screen electronic devices. Before application of an electronic device, a user may touch any position on the screen to input relevant fingerprint information. Then the electronic device conducts a verification to identify the user. The user who passes the verification is allowed to enter the operation interface, or the user can't enter the operation interface if failing the verification.

Currently, most of full screen electronic devices conduct a user identification verification through identifying a single fingerprint of a user when conducting an identification verification, and then full screen electronic devices make a determination on whether to unlock the electronic device or not. However, in this way, the application security of electronic devices is not high and the security requirements of users to electronic devices cannot be fulfilled.

### SUMMARY

According to embodiments of the present disclosure, a method for improving application security of an electronic device is provided.

Specifically, a method for controlling an electronic device is provide. The method includes: when an electronic device is in a locked state and receives at least two position information of fingerprints, lighting pixels in a light source area corresponding to the position information of fingerprints, wherein a screen of the electronic device corresponds to at least two light source areas arranged in topology, each of the at least two light source areas includes at least one pixel, and there are unlit pixels configured in an interval between adjacent light source areas; sampling fingerprint data on positions of the screen corresponding to the position information of fingerprints; identifying the sampled fingerprint data; and controlling the electronic device to unlock or to remain in a locked state based on the identification result.

In some embodiment, the sampled fingerprint data includes fingerprint information on positions of the screen corresponding to the position information of fingerprints.

In some embodiment, the sampled fingerprint data includes at least one selected from a group consisting of a topology structure information formed among all position information of fingerprints; and an input time sequence information of all position information of fingerprints.

In some embodiment, identifying the sampled fingerprint data includes matching the sampled fingerprint data with a relevant preset fingerprint data.

In some embodiment, controlling the electronic device to unlock or to remain in a locked state based on the identification result includes: when all sampled fingerprint data matches the relevant preset fingerprint data, controlling the electronic device to unlock, otherwise, controlling the electronic device to remain in a locked state.

According to an embodiment of the present disclosure, an electronic device is also provided. The electronic device includes: a light source adapted to, when an electronic device is in a locked state and receives at least two position information of fingerprints, light pixels in a light source area corresponding to position information of fingerprints, wherein a screen of the electronic device corresponds to at least two light source areas arranged in topology, each of the at least two light source areas includes at least one pixel and there are unlit pixels configured in an interval between adjacent light source areas; a sampling unit adapted to sample fingerprint data on positions of the screen corresponding to the position information of fingerprints; an identifying unit adapted to identify the sampled fingerprint data; and a control unit, adapted to control the electronic device to unlock or to remain in a locked state based on the identification result.

In some embodiment, the fingerprint data sampled by the sampling unit includes a fingerprint information on positions of the screen corresponding to the position information of fingerprints.

In some embodiment, the fingerprint data sampled by the sampling unit includes at least one selected from a group consisting of a topology structure information formed among all position information of fingerprints, and an input time sequence information of all position information of fingerprints.

In some embodiment, the identifying unit is adapted to match the sampled fingerprint data with a relevant preset fingerprint data.

In some embodiment, the control unit is adapted to control the electronic device to unlock when all the sampled fingerprint data matches the relevant preset fingerprint data, otherwise, to control the electronic device to remain in a locked state.

In some embodiment, the device further includes: a display panel, wherein the light source is configured on the display panel.

In some embodiment, the sampling unit includes a light sensor, adapted to sample light on positions of the screen corresponding to the position information of fingerprints.

In some embodiment, the screen of the electronic device includes a translucent cover plate, the display panel is disposed below the screen, the light sensor is disposed below the display panel, and light goes through the display panel into the light sensor.

According to embodiments of present disclosure, a computer readable storage medium storing computer instructions is provided, wherein the above method are performed once the computer instructions are executed.

According to embodiments of present disclosure, an electronic device is provided. The electronic device includes a memory device; and a processor, wherein the memory device is stored with computer instructions executable on the processor, and above method are performed once the processor executes computer instructions.

Compared with conventional technology, embodiments of the present disclosure have the following advantages.

According to embodiments of present disclosure, when an electronic device is in a locked state and receives at least two position information of fingerprints, the electronic device samples fingerprint data on positions of the screen corresponding to the position information of fingerprints, identifies the sampled fingerprint data, and controls the electronic device to unlock or to remain in a locked state based on the identification results. Therefore, fingerprint data of at least two input fingers are used to control the electronic device to improve the application security of the electronic device. Further, the screen of the electronic device includes at least two light source areas arranged in topology, and multiple sources of light are applied in imaging, which improves an efficient of imaging. Moreover, each of the at least two light source areas includes at least one pixel, light intensity of each of the at least two light source areas can be increased, thereby improving accuracy of fingerprint sampling and further improving quality of optical imaging.

Further, fingerprint information is sampled as well as a topology structure information among all position information of fingerprints and/or an input time sequence information among all position information of fingerprints. When an identification verification is conducted based on sampled fingerprint data, application security of the electronic device can be improved further to fulfill the high confidentiality requirement of users on electronic devices.

### BRIEF DESCRIPTION OF THE DRAWINGS

FIG. 1 schematically illustrates a flow diagram of a method for controlling an electronic device according to an embodiment of the present disclosure;

FIG. 2 schematically illustrates a structural diagram of an electronic device according to an embodiment of the present disclosure.

### DETAILED DESCRIPTION

Currently, most of full screen electronic devices conduct a user identification verification through identifying a single finger of a user when conducting an identification verification, to determine whether to unlock electronic devices or not. The application security of electronic devices are not high and hard to fulfill confidential requirement of users on electronic devices.

An embodiment of the present disclosure provides a method for controlling an electronic device, where the electronic device is controlled based on at least two input fingerprint data to improve the application security of the electronic device when the electronic device is in a locked state. Further, a screen of the electronic device corresponds to at least two light source areas arranged in topology, and multiple sources of light are applied in imaging, which improves an efficient of imaging. Moreover, each of the at least two light source areas includes at least one pixel, light intensity of each of the at least two light source areas can be increased, thereby improving accuracy of fingerprint sampling and further improving quality of optical imaging.

The foregoing objects, features and advantages of the present disclosure will become more apparent from the following detailed description of specific embodiments in conjunction with the accompanying drawings.

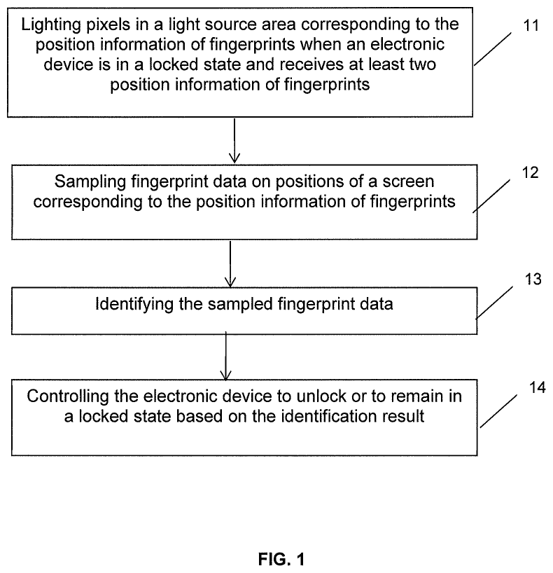

Referring to FIG. 1, a method for controlling an electronic device is provided according to an embodiment of the present disclosure. The method includes steps 11, 12, 13 and 14.

In 11, pixels are lighted in a light source area corresponding to a position information of fingerprints when an electronic device is in a locked state and receives at least two position information of fingerprints.

Wherein, a screen of the electronic device corresponds to at least two light source areas arranged in topology, each of the at least two light source areas includes at least one pixel and there are unlit pixels in an interval between adjacent light source areas.

In some embodiment, a plurality of pressure sensitive sensors may be preset below the screen of the electronic device, the number of the pressure sensitive sensors may be configured by a skilled in the art according to practical needs, which should not limit the protection scope of present disclosure. A pressure on the screen by fingers can be detected by the plurality of pressure sensitive sensors. When a finger presses the screen, a particular pressure sensitive sensor corresponding to the position where the finger presses can output corresponding signals. The signal includes a position information of the fingerprint of the finger pressed on the screen.

When the electronic device is in a locked state, if the position information of the fingerprint is output by the particular pressure sensitive sensor, pixels in a light source area corresponding to the position information of the fingerprint are lighted.

In some embodiment, a light source of the electronic device may include a plurality of pixels in order to improve the light intensity and range on the screen of the electronic device. The plurality of pixels are distributed in a plurality of light source areas. In some embodiment, each of the plurality of light source areas may include two, three or more than three pixels. There may be configured unlit pixels in an interval between adjacent light source areas, that is, adjacent light source areas are spaced apart by unlit pixels.

In some embodiment, at least two discrete light source areas can be lighted at the same time. Therefore, fingerprint data on multiple positions of the screen can be obtained, which can improve efficient of obtaining fingerprint data. Further, multiple pixels may be included in a light source area so that the brightness requirement for imaging can be fulfilled.

In some embodiment, there may be multiple types of topology structures configured for light source areas. In some embodiment, multiple light source areas may be configured in a single-pointed alignment, in a multiple-pointed alignment, in a linear alignment, in a parallel-lined alignment, in a ring alignment, in a dotted-lined alignment, or in a parallel-dotted-line alignment.

The interval between adjacent light source areas may be designed to be equal or not, which can be configured according to requirements of imaging quality and is not limited hereinafter. Of course, effects of hardware parameters of other imaging structure components in electronic devices can be considered during the configuration. The other imaging structure components may include display panel, light sensor, translucent cover plate, and the like.

In some embodiment, light source areas may take various shapes, for example, circular like shape, rectangle shape, diamond shape, triangle shape, direct line shape, parallel-lined shape, dotted-lined shape, parallel-dotted-lined shape, or the like. In some embodiment, light source areas take a shape of a direct line or a single-dot alignment.

In 12, fingerprint data are sampled on positions of screen corresponding to the position information of fingerprints.

In some embodiment, the sampled fingerprint data may include fingerprint information on positions of the screen corresponding to position information of fingerprints. In some embodiment, the fingerprint information may include point fingerprint information, middle fingerprint information, or ring fingerprint information and so on.

In some embodiment, the sampled fingerprint data may further include a topology structure information formed among all position information of fingerprints, and/or an input time sequence information of all position information of fingerprints.

In some embodiment, the topology structure information formed among all position information of fingerprints includes topology structure information formed among all positions where fingers press the screen. There may be multiple topology structures formed among all position information of fingerprints, such as triangle alignment, direct line alignment and so on.

In some embodiment, the input time sequence information among all position information of fingerprints includes alignment information of time points when fingers press the screen. Among them, there may be multiple types of input time sequence information of all position information of fingerprints. For an example, a point finger presses the screen first, and then a middle finger followed by a ring finger, that is, the input time sequences information is point finger-middle finger-ring finger. For another example, a middle finger presses the screen first, and then a point finger followed by a ring finger, that is, the input time sequences information is middle finger-point finger-ring finger.

In some embodiment, the topology structure information formed among all position information of fingerprints and the input time sequence information of all position information of fingerprints can be obtained through sampling an output by a pressure sensitive sensor.

In 13, the sampled fingerprint data is identified.

In some embodiment, identifying the sampled fingerprint data includes matching the sampled fingerprint data with a relevant preset fingerprint data.

In some embodiment, the fingerprint data may include the fingerprint information on positions of the screen corresponding to the position information of fingerprints. The fingerprint information of a point finger, of a middle finger and of a ring finger can be preset in the electronic device to unlock the electronic device. The sampled fingerprint information is compared with the preset fingerprint information one by one to identify the sampled fingerprint information.

In some embodiment, if fingerprint data also includes the topology structure information formed among all position information of fingerprints, the topology structure information can be preset in the electronic device to unlock the electronic device. The sampled topology structure information is compared with the preset topology structure information to identify the sampled fingerprint information.

In some embodiment, if the fingerprint data also includes input time sequence information of all position information of fingerprints, the input time sequence information can be preset in the electronic device to unlock the electronic device. The sampled input time sequence information is compared with the preset input time sequence information to identify the sampled input time sequence information.

In 14, the electronic device is controlled to be unlocked or remained in a locked state based on the identification result.

In some embodiment, if the sampled fingerprint data completely matches the preset relevant fingerprint data, the electronic device is controlled to be unlocked, or is controlled to remain in a locked state.

In some embodiment, if the sampled fingerprint data only includes fingerprint information on positions of the screen corresponding to the position information of fingerprints, and if the sampled fingerprint data completely matches the fingerprint information preset in the electronic device, the electronic device is controlled to be unlocked, or is controlled to remain in a locked state.

In some embodiment, if the sampled fingerprint data includes fingerprint information on positions of the screen corresponding to the position information of fingerprints, and the topology structure information formed among all position information of fingerprints, and if the sampled fingerprint data completely matches the fingerprint information preset in the electronic device, and the sampled topology structure information completely matches the preset topology structure information, the electronic device is controlled to be unlocked, or is controlled to remain in a locked state.

In some embodiment, if the sampled fingerprint data includes fingerprint information on positions of the screen corresponding to the position information of fingerprints, and time sequence information of all position information of fingerprints, and if the sampled fingerprint data completely matches the fingerprint information preset in the electronic device, and the sampled time sequence information completely matches the preset time sequence information, the electronic device is controlled to be unlocked, or is controlled to remain in a locked state.

In some embodiment, if sampled fingerprint data includes fingerprint information on positions of the screen corresponding to the position information of fingerprints, the topology structure information formed among all position information of fingerprints, and the time sequence information of all position information of fingerprints, and if the sampled fingerprint data completely matches the fingerprint information preset in the electronic device, the sampled topology structure information completely matches the preset topology structure information, and the sampled time sequence information completely matches the preset time sequence information, the electronic device is controlled to be unlocked, or is controlled to remain in a locked state.

In some embodiments of present disclosure, at least one information is sampled from a group consisting of the topology structure information formed among all position information of fingerprints and the time sequence information of all position information of fingerprints as well as the fingerprint information, when an identification verification is conducted based on sampled fingerprint data, application security of electronic device can be improved to meet high confidential requirements of users on electronic devices.

From above, according to embodiments of present disclosure, the method for controlling an electronic device is based on input data of at least two fingerprints to control the electronic device to be unlocked or not, which improves the application security of the electronic device. Further, the screen is configured with at least two light source areas arranged in topology, and at least one pixel is configured in each of at least two light source areas, therefore, brightness of each of the at least two light source areas can be increased, and accuracy of fingerprint sampling and quality of optical imaging can thus be improved.

For better understanding and realizing the present disclosure, a user terminal and a computer readable storage medium corresponding to above method are described in detail hereinafter.

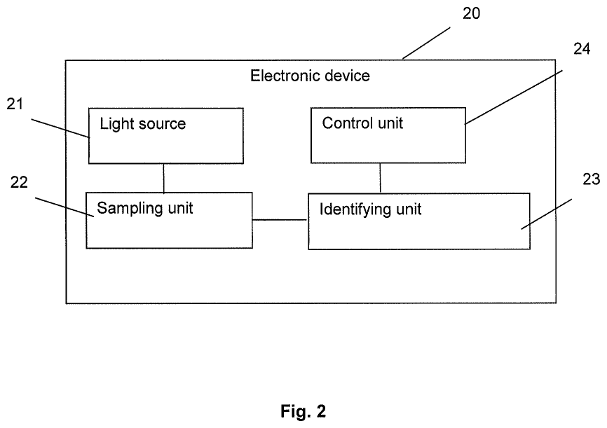

Referring to FIG. 2, an electronic device 20 is provided. The electronic device 20 may include a light source 21, a sampling unit 22, an identifying unit 23 and a control unit 24.

The light source 21 is adapted to, when an electronic device is in a locked state and receives at least two position information of fingerprints, light pixels in a light source area corresponding to a position information of fingerprints, wherein a screen of the electronic device includes at least two light source areas arranged in topology, each of the at least two light source areas includes at least one pixel and there are unlit pixels configured in an interval between adjacent light source areas.

The sampling unit 22 is adapted to sample fingerprint data on positions of the screen corresponding to the position information of fingerprints.

The identifying unit 23 is adapted to identify sampled fingerprint data.

The control unit 24 is adapted to control the electronic device to unlock or to remain in a locked state based on the identification result.

In some embodiment, the fingerprint data sampled by the sampling unit 22 may include fingerprint information on positions of screen corresponding to the position information of fingerprints.

In some embodiment, the fingerprint data sampled by the sampling unit 22 may further include at least one selected from a group consisting of a topology structure information formed among all the position information of fingerprints, and an input time sequence information of all position information of fingerprints.

In some embodiment, the identifying unit 23 is adapted to match the sampled fingerprint data with a relevant preset fingerprint data.

In some embodiment, the control unit 24 is adapted to control the electronic device to unlock when the sampled fingerprint data matches the relevant preset fingerprint data, otherwise, to control the electronic device to remain in a locked state.

In some embodiment, the electronic device 20 may further includes a display panel, wherein the light source is configured on the display panel.

In some embodiment, the sampling unit 22 may include a light sensor adapted to sample light on positions of the screen corresponding to the position information of fingerprints.

In some embodiment, the light sensor is adapted to obtain light and includes multiple photosensitive components. The multiple photosensitive components may be disposed under the display panel individually. Light may go through the display panel to the light sensor. The light sensor may be used to sample images under the screen, such as to obtain fingerprints.

In some embodiment, a screen of the electronic device 20 may include a translucent cover plate. The light source 21 and the sampling unit 22 are disposed below the translucent cover plate, and light goes through the display panel into the light sensor.

In some embodiment, the translucent cover plate is a single-layered board structure or a multiple-layered board structure. In some embodiment, the single-layered board structure may be a glass cover plate or a cover plate made of an organic translucent material. The single-layered cover plate may also be other plate with other functions, such as a touch screen. The multiple-layered board structure may be a multiple-layered glass cover plate or a multiple-layered organic translucent cover plate, or a combination of a glass cover plate and an organic translucent cover plate.

In some embodiment, imaging structure below the screen of the electronic device 20 may be a total reflection imaging of optical fingerprint without lens screen. The specific principle includes that when fingers contact with the translucent cover plate, there is air in fingerprint depressions. Light with incident angles larger than the total reflection critical angle is totally reflected and the light sensor thus receives bright light. However, the fingerprint protrudings contact with upper surface of the translucent cover plate, no total reflection happens on it, therefore, the light sensor receives darker light. In this way, the identifying unit 23 can identify a fingerprint image.

An embodiment of the present disclosure further provides a computer readable storage medium storing computer instructions. When the computer instructions are executed, the method for controlling the electronic device as described in above embodiments is performed.

In some embodiment, the computer readable storage medium may be a ROM, a RAM, a magnetic disc or an optical disc.

An embodiment of the present disclosure further provides an electronic device, includes a memory device and a processor, wherein the memory device is stored with computer instructions executable on the processor. When the computer instructions are executed by the processor, the method for controlling the electronic device as described in above embodiments is performed.

Although the present disclosure has been disclosed above with reference to preferred embodiments thereof, it should be understood that the disclosure is presented by way of example only, and not limitation. Those skilled in the art may modify and vary the embodiments without departing from the spirit and scope of the present disclosure.

What is claimed is:

1. A method for controlling an electronic device, comprising:
when the electronic device is in a locked state and receives at least two position information of fingerprints, lighting pixels in a light source area corresponding to the position information of fingerprints, wherein a screen of the electronic device corresponds to at least two light source areas arranged in topology, each of the at least two light source areas comprises at least one pixel, and there are unlit pixels configured in an interval between adjacent light source areas;
sampling fingerprint data on positions of the screen corresponding to the position information of fingerprints;
identifying the sampled fingerprint data; and
controlling the electronic device to unlock or to remain in a locked state based on the identification result.

2. The method according to claim 1, wherein the sampled fingerprint data comprises:
fingerprint information on positions of the screen corresponding to the position information of fingerprints.

3. The method according to claim 2, wherein the sampled fingerprint data comprises at least one selected from a group consisting of:
a topology structure information formed among all position information of fingerprints; and
an input time sequence information of all position information of fingerprints.

4. The method according to claim 2, wherein identifying the sampled fingerprint data comprises matching the sampled fingerprint data with a relevant preset fingerprint data.

5. The method according to claim 4, wherein controlling the electronic device to unlock or to remain in a locked state based on the identification result comprises:
when all sampled fingerprint data matches the relevant preset fingerprint data, controlling the electronic device to unlock, otherwise, controlling the electronic device to remain in a locked state.

6. An electronic device, comprising:
a light source, adapted to, when an electronic device is in a locked state and receives at least two position information of fingerprints, light pixels in a light source area corresponding to position information of fingerprints, wherein a screen of the electronic device corresponds at least two light source areas arranged in topology, each of the at least two light source areas comprises at least one pixel and there are unlit pixels configured in an interval between adjacent light source areas;
a sampling unit, adapted to sample fingerprint data on positions of the screen corresponding to the position information of fingerprints;
an identifying unit, adapted to identify the sampled fingerprint data; and
a control unit, adapted to control the electronic device to unlock or to remain in a locked state based on the identification result.

7. The device according to claim 6, wherein the fingerprint data sampled by the sampling unit comprises:
a fingerprint information on positions of the screen corresponding to the position information of fingerprints.

8. The device according to claim 7, wherein the fingerprint data sampled by the sampling unit comprises at least one selected from a group consisting of:
a topology structure information formed among all position information of fingerprints, and
an input time sequence information of all position information of fingerprints.

9. The device according to claim 6, wherein the identifying unit is adapted to match the sampled fingerprint data with a relevant preset fingerprint data.

10. The device according to claim 9, wherein the control unit is adapted to control the electronic device to unlock when all the sampled fingerprint data matches the relevant preset fingerprint data, otherwise, to control the electronic device to remain in a locked state.

11. The device according to claim 6, further comprising:
a display panel, wherein the light source is configured on the display panel.

12. The device according to claim 11, wherein the sampling unit comprises:
a light sensor, adapted to sample light on positions of the screen corresponding to the position information of fingerprints.

13. The device according to claim 12, wherein the screen of the electronic device comprises a translucent cover plate, the display panel is disposed below the screen, the light sensor is disposed below the display panel, and light goes through the display panel into the light sensor.

14. A computer readable storage medium storing computer instructions, wherein the method according to claim 1 is performed once the computer instructions are executed.

15. An electronic device, comprising:
a memory device; and
a processor,
wherein the memory device is stored with computer instructions executable on the processor, and the method according to claim 1 is performed once the processor executes the computer instructions.
